(19) United States
(12) Patent Application Publication
(10) Pub. No.: US 2006/0017788 A1
(43) Pub. Date: Jan. 26, 2006

(54) Fluid delivery component

(75) Inventors: David R. Otis JR., Corvallis, OR (US); Ricardo G. Diaz-Felipe, Aguadilla, PR (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: Hewlett-Packard Development Company, L.P.

(21) Appl. No.: 10/894,788

(22) Filed: Jul. 20, 2004

(51) Int. Cl. B41J 2/175

(52) U.S. Cl. 347/85

(57) ABSTRACT

A fluid delivery component includes a shell with a bladder. The bladder bag may have at least one dimension greater than a corresponding dimension of the shell. The bladder may include a plurality of nested bags and/or may include a pillow-shaped bag.

### BACKGROUND

Fluid of a fluid delivery system is often securely contained in a bag that allows for introduction of fluid thereinto and extraction of fluid therefrom. Often a significant volume of remnant fluid remains in the discarded bag after maximum extraction. It is difficult to maximize volumetric efficiency of the containment, while maintaining performance.

### BRIEF DESCRIPTION OF THE DRAWINGS

FIG. 1 illustrates a fluid delivery system in an embodiment.

FIG. 2 is an exploded view of an embodiment of a fluid delivery component.

FIG. 3 is a cross sectional view of a bladder taken along line 3-3 in FIG. 2.

FIG. 3A is a cross sectional view of a bladder in an embodiment.

FIG. 4 is a side view of a bladder inside a fluid delivery component in an embodiment.

FIG. 5 is a top view of an embodiment of a fluid delivery component illustrated on a reservoir.

FIG. 6 is a perspective view of an embodiment of a fluid delivery component.

### DETAILED DESCRIPTION

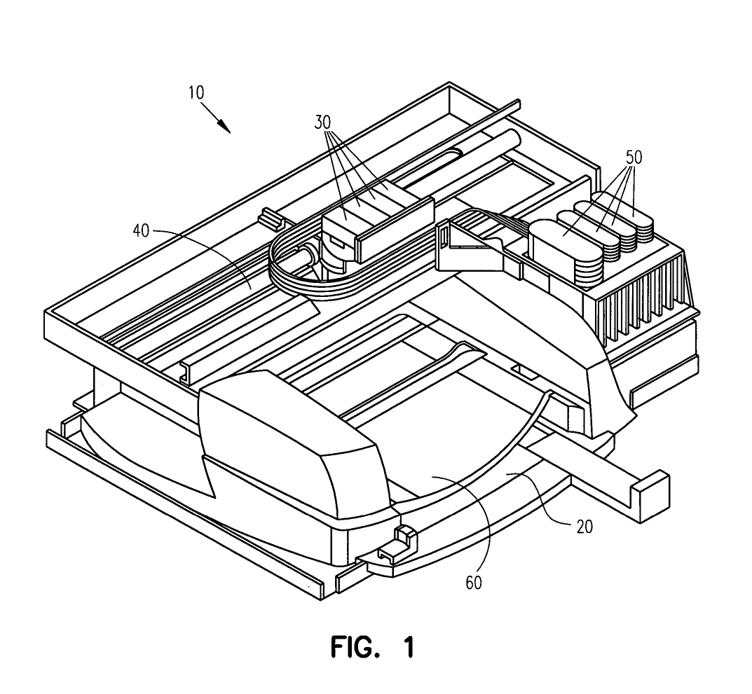

FIG. 1 illustrates a fluid delivery system 10 in an embodiment. In embodiments, the system 10 is a recording device, a fluid ejection device, or a printer. In the system 10, media is placed on a media input tray 20 and transported past one or more fluid cartridges 30, in an embodiment. The fluid cartridges 30 are transported, in an orthogonal direction to the media movement, along rod 40 to deliver fluid to the media, such as printing with fluid in an embodiment. In an embodiment, the system 10 stores one or more fluid delivery components 50 that are fluidically coupled with the fluid cartridges 30. In an embodiment, after the media is transported past the cartridges 30, the media is deposited onto a media output tray 60.

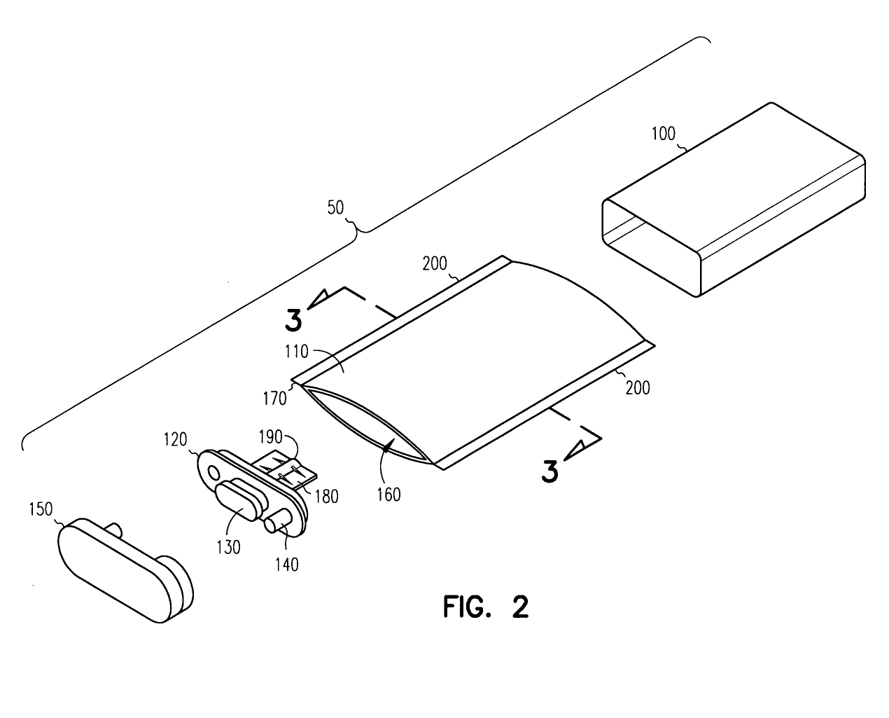

FIG. 2 is an exploded view of an embodiment of one of the fluid delivery components 50 of FIG. 1. In embodiments, the fluid delivery component 50 is a fluid container, a fluid supply, or a fluid delivery apparatus. The component 50 has a housing 100, such as shell, which contains a flexible fluid reservoir 110, in an embodiment. In embodiments, the reservoir 110 includes a bladder, and/or may include a bag. The shell 100 is coupled with a chassis 120, which houses a pump 130. The chassis 150 includes a fluid outlet 140 fluidically coupled with the reservoir 110, in an embodiment. A protective cap 150 at least partially encloses the chassis 120. The shell 100, the chassis 120, and the cap 150 are coupled together to form the component 50. The cap 150 has apertures, which allow access to the pump 130 and to the fluid outlet 140, in an embodiment.

As shown in FIG. 2, the chassis 120 has a fin 180 extending therefrom on a bottom side, opposite a pump side, in an embodiment. The fin 180 inserts into an opening 160 of the reservoir 110 along a top side 170 of the reservoir 110, in an embodiment. In an embodiment, the top side 170 of the reservoir couples about the fin 180 to form a fluidic seal. In an embodiment, the top side 170 is heat staked to the fin 180. The fin 180 has a port 190 therethrough fluidically coupling the chassis 120 with the reservoir 110, in an embodiment. In embodiments, the port 190 includes a tunnel, or an opening therein to fluidically couple with the fluid outlet 140.

In an embodiment, the chassis 120 includes a fill port fluidically coupled with port 190 and an exhaust port. Fluid can be added to the component 50 through the fill port of the chassis, while air displaced by the added fluid is exhausted through the exhaust port. As the reservoir 110 is filled, it expands so as to substantially fill the shell 100. The protective cap 150 is placed on the component after the reservoir is filled.

The pump 130 of the illustrated embodiment is actuated by pressing a diaphragm of the pump inward to decrease the volume and increase the pressure within a chamber in the chassis. Fluid forced from the chamber exits through the fluid outlet 140. When the diaphragm is released, the volume in the chamber increases, thereby decreasing pressure. The decreased pressure within the chamber draws fluid from the reservoir into the chamber. In an embodiment, the diaphragm pump can be reliable and well suited for use in the component. However, other types of pumps may also be used. For example, a piston pump, a bellows pump, or other types of pumps might be adapted for use in embodiments.

In an embodiment, slow ingress of air is allowed into the shell 100 as fluid is depleted from the reservoir 110 to maintain the pressure inside the shell as generally the same as an ambient pressure. Otherwise, a negative pressure may develop inside the shell and inhibit the flow of fluid from the reservoir. In an embodiment, the ingress of air is limited, in order to maintain a high humidity within the shell and minimize water loss from the fluid.

In an embodiment, the chassis 120 is molded of an easily heat-stakeable material that may be recyclable. The chassis may be molded of high-density polyethylene. The material of the chassis may vary in embodiments. In an embodiment shown in FIG. 2, the shell 100 includes a material made of polypropylene. In an embodiment, the shell has a thickness of about one millimeter. The shell 100 may provide substantially robust protection for the reservoir 110. The material and thickness of the shell may vary in embodiments.

In an embodiment, the reservoir 110 is formed of at least one folded substrate. The folded substrate forms two sidewalls of the reservoir. The sidewalls are sealed around a periphery 200 of the reservoir 110 at two opposing sides of the folded substrate. In the embodiment, heat staking can be used to seal at least part of the perimeter of the sidewalls to form the reservoir bag.

In another embodiment, the reservoir is formed of at least two substrates. One substrate is placed over another substrate to form two sidewalls of the reservoir. Three (3) edge regions of the respective sidewalls are sealed together along the periphery 200 of the reservoir to form the opening 160 along a fourth edge region or top side 170 of the reservoir. In the embodiment, heat staking can be used to seal at least part of the edges of the sidewalls to form the reservoir bag. The top side 170 may be sealed with the fin 180 of the chassis 120 to fluidically seal the flexible fluid reservoir 110.

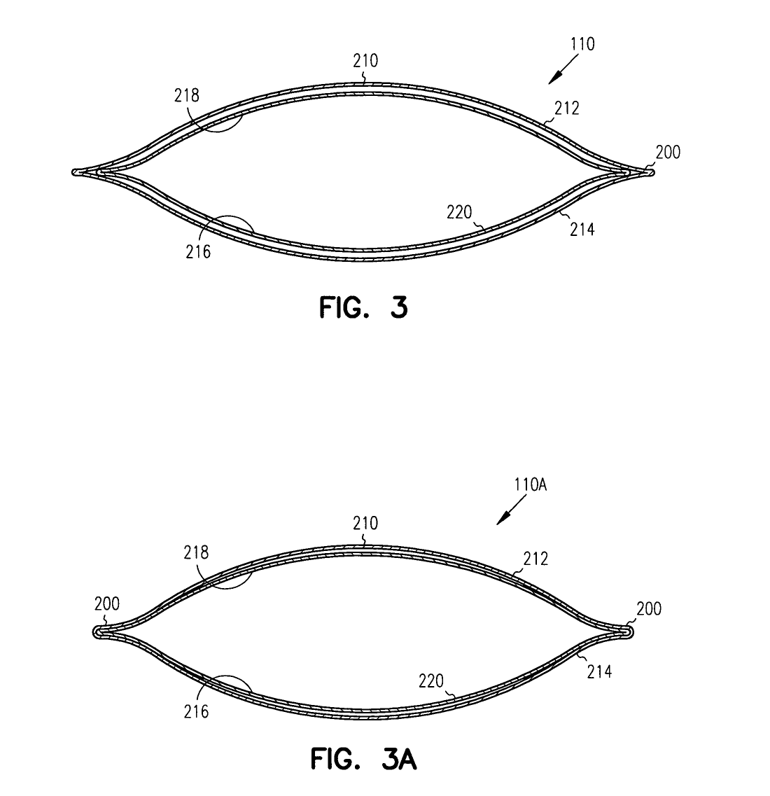

In the embodiment shown in the cross-sectional view of FIG. 3, the reservoir 110 includes a plurality of nested bags 210, 220. In a particular embodiment, the reservoir 110 includes a first bag 210 and a second bag 220 enclosed by the first bag 210. In this embodiment, the reservoir includes a double-walled bladder to contain fluid.

In an embodiment shown in FIGS. 2 and 3, the nested bags 210, 220 each have a pillow shape. The pillow shaped bag may be a rectangular bag made of flexible material and may have an opening at one end along a transverse side. The pillow shaped bag may be filled with fluid, such as ink.

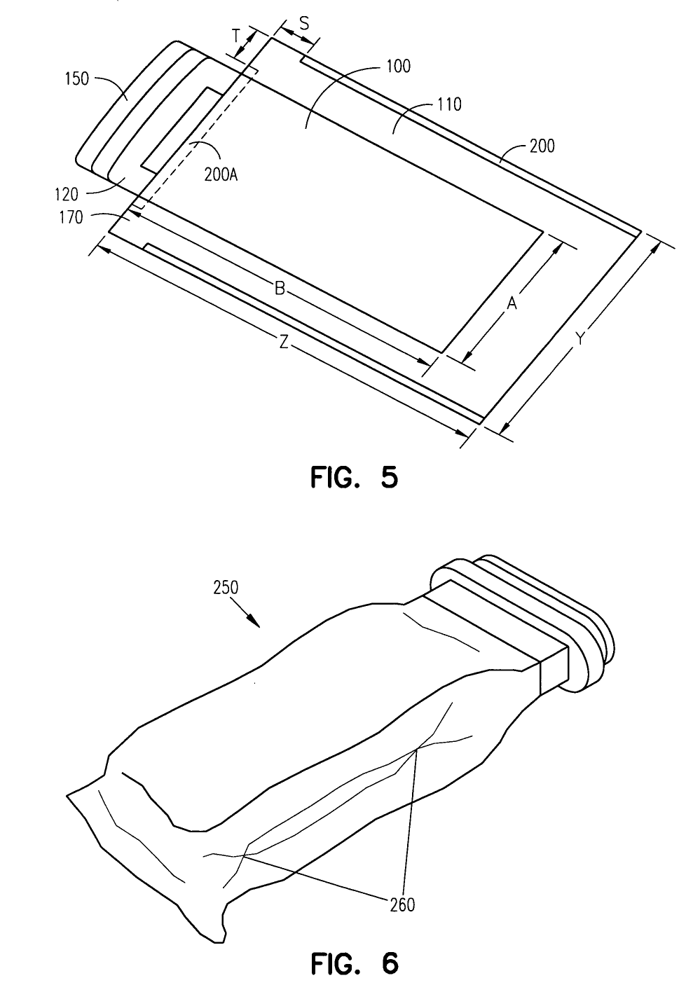

The first bag 210 includes first and second sidewalls 212, 214 joined at two of their respective edge regions directly to one another to form a pillow shape and to form the at least partially sealed periphery 200 of the reservoir. The second bag 220 has third and fourth sidewalls 216, 218 joined at two of their respective edge regions, or selvages, directly to one another to form a pillow shape and the at least partially sealed periphery 200 of the reservoir. In another embodiment described and shown in FIG. 5, the reservoir is shaped as a gusset bag.

In an embodiment, the nested bags are each formed from a large substrate that is folded and sealed along two opposing edge regions. The first and second sidewalls 212, 214 of the first bag 210 are formed from folding over a large substrate, and are sealed at least along two edge regions respectively, as described above. The third and fourth sidewalls 216, 218 of the second bag 220 may also be formed from folding over a large substrate.

In another embodiment, the nested bags are each formed from separate substrates that are sealed along three edge regions. The sidewalls 212, 214 are separate substrates, and are sealed together along three (3) edge regions, respectively, including a bottom edge region. In another embodiment, the sidewalls 216, 218 of the second bag 220 are sealed together along three (3) edge regions.

At least two opposing edge regions of the first bag sidewalls 212, 214 are sealed together. Separately, at least two opposing edge regions of the second bag sidewalls 216, 218 are sealed together, as shown in the embodiment of FIG. 3. In this embodiment, the nested bags 210, 220 may move independently of each other in the shell 100.

In an additional embodiment, edge regions of the sidewalls 216, 218 are sealed in between edge regions of the sidewalls 212, 214, as shown in a reservoir 110A of FIG. 3A. The edge regions of the first and second bags 210, 220 are all sealed together in this embodiment of FIG. 3A. In an embodiment, the edge regions of the bags are heat-staked together to form the sealed periphery 200 of the reservoir 110. In this embodiment, the first and second bags 210, 220 share edge regions and are less likely to move substantially independently of each other in the shell 100.

In an embodiment, the reservoir 110 includes a polymer layer. The first bag 210 may include at least one of a barrier layer and a metallic layer. In an embodiment, the second bag 220 includes at least one of a polymer layer and a translucent layer. In an embodiment, the first bag 210 may include a substantially impact-resistant material. In an embodiment, the second bag 220 includes a substantially fluid-impervious material. In an embodiment, the reservoir is substantially collapsible and flexible. In an embodiment, the reservoir includes bags that together have a substantially low stiffness, which may be due at least in part to the bags 210 and 220 being substantially separate, and the bags each being relatively thin, as discussed below in more detail.

In an embodiment, the material from which is formed the second bag 220 may include at least one of the following properties: provides substantially effective moisture-barrier, provides substantially enough strength to substantially resist rupture, substantially flexible enough to stretch without substantially breaking, and substantially able to seal to a polymer (FIN), including, for example high-density polyethylene (HDPE).

In an embodiment, the fluid-impervious material is chosen from a group including (1) low-density, linear low-density or ultra-low-density or single-site catalyst polyethylene (LDPE, LLDPE, ULDPE or SSCPE) or (2) co-extrusions thereof with core materials of bi-axially oriented nylon (BON) or ethyl vinyl alcohol (EVOH), e.g. co-extruded LLDPE/BON/LLDPE or LLPDE/EVOH/LLDPE, or polyvinylidene fluoride (PVDF). In an embodiment, the second, inner bag 220 is approximately between 1 and 3 mils (0.001 inches to 0.003 inches) thick.

In an embodiment, the first, outer bag 210 may exhibit at least one of the following properties: provide a substantial moisture and air barrier, add substantial strength to substantially resist rupture and to substantially protect the inner bag, act as a redundant seal should the inner bag break, and having capability of sealing to a polymer and to the inner second bag 220. In accordance with an embodiment, the impact-resistant material includes a polymer/thin-metal laminate of bonded layers wherein the polymers are chosen from a group including linear (the linear orientation may positively affect impact strength), low-density polyethylene (LLDPE), polyester (PET), biaxially-oriented nylon (BON), and oriented polypropylene (OPP), and wherein the metals are chosen from a group including aluminum (Al) and silver (Ag). One such workable embodiment of a laminar structure (from innermost to outermost laminate) is LLDPE/PET-MET/MET-PET/LLDPE. Another embodiment (also from innermost to outermost laminate) is LLDPE/PET-NET/BON. In one embodiment, the metallized polyester layers are formed by vapor or sputter deposition of metal particles onto thin films of polyester, and act as substantial barriers to air and moisture. The layers of the laminar structure that form the outer films of the sidewalls may be bonded by any suitable adhesive. In an embodiment, the first bag 210 has a thickness approximately between 1 and 3 mils.

It will also be appreciated that the choice of materials for the inner and outer films render the inner films flexible and substantially impervious to penetration by fluid or liquid toner, and render the outer films flexible and substantially impervious to penetration by air or moisture, in an embodiment.

In an embodiment, the first bag 210 includes about a 0.6 mil thick (10.8 lbs/rm) biaxially oriented nylon 6 layer coupled with about a 0.02 mil thick (1.8 lbs/rm) adhesive to about a 500 angstrom thick (2.5 O.D.) silver metallization layer coupled with about a 0.48 mil thick (10.7 lbs/rm) oriented polyester coupled with about a 0.02 mil (1.8 lbs/rm) adhesive to about a 0.5 mil thick (7.2 lbs/rm) linear low density polyethylene film. However, the first bag 210 may include less or more layers, and different materials in the layers.

In an embodiment, the second bag 220 includes about a 0.6 mil thick (8.6 lbs/rm) linear low density polyethylene layer coupled with a 0.2 mil thick (2.8 lbs/rm) modified LLD (Tie) layer coupled with about a 0.4 mil thick (7.5 lbs/rm) nylon 6 layer coupled with a second about 0.2 mil thick (2.8 lbs/rm) modified LLD (Tie) layer coupled with a second about a 0.6 mil thick (8.6 lbs/rm) linear low density polyethylene layer. However, the second bag 220 may include less or more layers, and different materials in the layers.

In between the first and second bags 210, 220, respectively, is an air gap, in an embodiment. The air gap may be in between one of the polyethylene layers of the second bag 220 and the polyethylene film layer of the first bag 210. Between the inner and outer film layers is about a 1 atmosphere volume of air that acts as a shock absorber to reduce the possibility of rupturing the inner film layer (the second bag 220) that contains fluid, in an embodiment. In an embodiment, the fluid container 50 resists leakage in normal use, and when accidentally dropped.

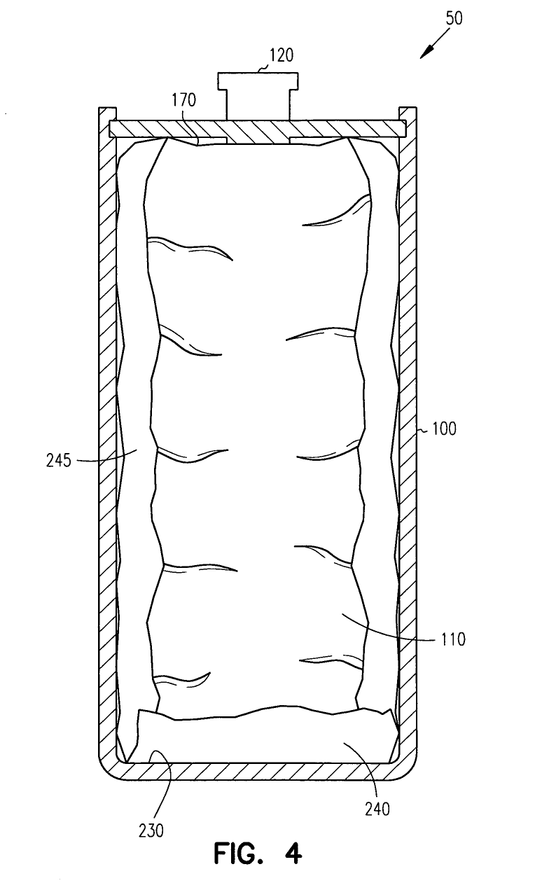

FIG. 4 is a side view of the reservoir 110 inside the fluid delivery component 50 just behind a sidewall of the shell 100 in an embodiment. The shell 100 has an interior bottom wall 230. The outer layer of the reservoir, or the first bag 210, substantially contacts the interior bottom wall 230 of the shell when the reservoir is substantially full, in an embodiment. The first bag 210 may substantially contact the interior, including interior sidewalls of the shell, when full of fluid, to a maximum efficiency and fluid capacity. The second bag 220 may also be substantially pressed against the first bag 210, when the reservoir is full of fluid.

In the embodiment illustrated in FIG. 4, where the reservoir 110, including the first and second bags 210, 220, has larger dimensions than the shell 100, the reservoir 110 is folded before inserted into the shell 100. The reservoir 110 may be folded up along a bottom to form a bottom fold 240, and the sides of the reservoir 110 may be folded over to form side folds 245. In an additional embodiment, the reservoir 110 is inserted into the shell 100 without folding over the bottom and sides.

In an embodiment, the shell 100 and the flexible reservoir 110, which the shell contains, have the capacity to hold up to about two hundred (200) cubic centimeters (cc) of fluid. In an embodiment, the reservoir 110 holds 69 cc of fluid. In an embodiment, the shell 100 is approximately 50-100 millimeters wide, about 10-20 millimeters deep and about 50-150 millimeters high. In a particular embodiment, the shell is about 75 millimeters wide, 15 millimeters deep and 115 millimeters high. Other dimensions are within the scope of embodiments for the shell. In the embodiment shown in FIG. 5, the fluid delivery component, including the shell 100, the chassis 120, and the cap 150, is positioned over the reservoir 110 to illustrate the dimensions of the reservoir with respect to the housing/shell 100. In operation, however, the reservoir 110 is inside the housing 100 of the fluid delivery component 50 as shown in FIG. 4.

As shown in an embodiment of FIG. 5, the reservoir 110 is sized to have at least one dimension greater than a corresponding dimension of the shell 100. In an embodiment, a length Z of the reservoir is greater than a length B of the shell, for example, by about half a width A of the shell. In an embodiment, a width Y of the reservoir is greater than the width A of the shell. The reservoir may be flexible to substantially fit within the shell. In an embodiment, at least one dimension (Y or Z) of the reservoir is about 25% to about 35% greater than the corresponding dimension (A or B, respectively) of the shell, and the reservoir is flexible to substantially fit within the shell.

In an embodiment, the flexible reservoir 110 is in a range of 50 to 150 millimeters wide in the “Y” direction, and about 100 to 200 millimeters long in the “Z” direction. In a particular embodiment, the flexible reservoir 110 is approximately 95 millimeters wide in the “Y” direction, and 140 millimeters long in the “Z” direction.

In an embodiment, along the top side 170 of the reservoir, the sidewalls of the bags 210 and 220 are sealed to each other along periphery 200A, leaving reservoir opening 160 between the sidewalls of the bag 220 opened to receive the fin 180 of the chassis 120 (shown in FIGS. 2 and 3). In a particular embodiment, the sidewall 212 of bag 210 (shown in FIG. 3) and sidewall 218 of bag 220 (shown in FIG. 3) are sealed along periphery 200A of the reservoir shown in FIG. 5. In an embodiment, the sidewall 214 of bag 210 (shown in FIG. 3) and sidewall 216 of bag 220 (shown in FIG. 3) are sealed along periphery 200A of the reservoir 110.

In an additional particular embodiment, along the top side 170 of the reservoir 110, a certain length “T” of the top side 170 is not sealed with the sealed periphery 200A in an embodiment. In an embodiment, length T of the top side 170 is adjacent each reservoir corner of the top side 170. In an embodiment, the periphery is not sealed along T to aid in inserting the chassis 120 into the reservoir opening 160 along the top side 170. After the fin 180 of the chassis 120 is inserted, the reservoir opening 160 between sidewalls of the second bag is sealed about the chassis 120, and each length T along the top side 170 is sealed as well. In another embodiment, the sidewalls of the bags 210 and 220 are not sealed to each other along the entire length of its top side 170 until the fin 180 is inserted between sidewalls of the second bag.

In an embodiment illustrated in FIG. 5, the sidewall edge regions along two sides of the periphery 200 of the reservoir 110 are not sealed along the entire length of the reservoir 110. In particular, near the top side 170 of the reservoir 110, a certain length S of each periphery 200 is not sealed in an embodiment. In an embodiment, length S is adjacent each reservoir corner where length T is similarly not sealed. In an embodiment, the periphery is not sealed along S to aid in inserting the chassis 120 into the reservoir opening 160 along the top side 170. After the chassis 120 is inserted into the reservoir opening 160, each length S is sealed with the sealing of the opening 160 about the chassis 120.

In an embodiment, length S may be about 10 millimeters to about 20 millimeters. In a particular embodiment, length S may be about 15 millimeters. The length S may be within 1 millimeter of the edge of the sidewalls. The sealed periphery 200 may be about 1 millimeter to about 5 millimeters in width. In a particular embodiment, the sealed periphery 200 may be about 3 millimeters in width.

In an embodiment, length T may be about 1 millimeter to about 10 millimeters. In a particular embodiment, length T may be about 6 millimeters. The entire length of length T may be within 1 millimeter of the edge of the sidewalls. The sealed periphery 200A may be about 1 millimeter to about 5 millimeters in width. In a particular embodiment, the sealed periphery 200A may be about 2 millimeters in width.

FIG. 6 illustrates another embodiment of the reservoir. In the embodiment, the reservoir is a gusset bag 250 having pleats 260. In an embodiment, the gusset bag 250 includes a plurality of nested bags. The nested bags are configured at least in a base region thereof as a generally right parallelepiped, wherein the right parallelepiped configuration is nominally maintained at least in part by one or more pleats 260 formed in the base region of the nested bags. Other pleating arrangements and configurations are contemplated, as are alternative methods of forming approximately right angles and corners, in the double-walled bladder, and all are within the spirit and scope of the disclosure. In an embodiment, the nested bags have at least one dimension greater than a corresponding dimension of the shell 100.

The illustrations of embodiments described herein are intended to provide a general understanding of the structure of various embodiments, and they are not intended to serve as a complete description of all the elements and features of apparatus and systems that might make use of the structures described herein. Applications that may include the apparatus and systems of various embodiments broadly include a variety of electronic and fluidic systems. In embodiments, the broad applicability includes fluid- or liquid-toner-containment, and has more particular applicability to fluid-jet or laser systems having replaceable fluid supplies. In an embodiment, fluid-containment systems contain fluid or liquid toner and yield more than approximately 90% of the fluid contained therein, thus greatly increasing containment and extraction efficiency and reducing waste.

FIGS. 1 to 6 are merely representational and are not drawn to scale. Certain proportions thereof may be exaggerated, while others may be minimized. Many other embodiments will be apparent to those of skill in the art upon reviewing the above description. Parts of some embodiments may be included in, or substituted for, those of other embodiments. While the foregoing examples of dimensions and ranges are considered typical, the various embodiments are not limited to such dimensions or ranges.

The accompanying drawings that form a part hereof show by way of illustration, and not of limitation, specific embodiments in which the subject matter may be practiced. Embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus the following claims are hereby incorporated into the Detailed Description, with each claim standing on its own as a separate embodiment.

It will be readily understood to those skilled in the art that various other changes in the details, material, and arrangements of the parts and method stages, which have been described and illustrated in order to explain the nature of embodiments herein may be made without departing from the principles and scope of embodiments as expressed in the subjoined claims.

1. A fluid delivery bladder comprising:
a first pillow-shaped bag including:
a first sidewall having an edge region substantially surrounding a first open region;
a second sidewall having an edge region substantially surrounding the first open region, wherein the edge region of the first sidewall is coupled with the edge region of the second sidewall to form the first pillow-shaped bag; and
a second pillow-shaped bag within the first pillow-shaped bag and including:
a third sidewall having an edge region substantially surrounding a second open region;
a fourth sidewall having an edge region substantially surrounding the second open region, wherein the edge region of the third sidewall is coupled with the edge region of the fourth sidewall to form the second pillow-shaped bag.

2. The bladder of claim 1 wherein the first bag includes at least one of a metallized layer and a barrier layer.

3. The bladder of claim 1 wherein the second bag includes at least one of a transparent layer and a layer that is substantially resistant to breaking.

4. A component of a fluid delivery system comprising:
a shell; and
a reservoir within the shell, wherein the reservoir includes:
at least one dimension greater than a corresponding dimension of the shell;
a first sidewall having an edge region substantially surrounding an open region; and
a second sidewall having an edge region substantially surrounding the open region,
wherein the edge region of the first sidewall is coupled with the edge region of the second sidewall to form a pillow-shaped bag.

5. The component of claim 4 wherein the bag has a single-ply film.

6. The component of claim 4 wherein the reservoir further includes a plurality of nested pillow-shaped bags.

7. The component of claim 6 wherein each of the plurality of nested pillow-shaped bags include a periphery, wherein the plurality of nested pillow-shaped bags is sealed along the respective peripheries.

8. The component of claim 4 wherein the at least one dimension of the reservoir is about 25% to about 35% greater than the corresponding dimension of the shell, wherein the reservoir is substantially flexible to substantially fit within the shell.

9. The component of claim 4 wherein the reservoir has an opening along a top side, the component further comprising a chassis with a fin to slide into the opening, wherein the reservoir surrounds and couples with the fin along the top side to substantially seal the reservoir, wherein the fin has a tunnel therethrough fluidically coupling with an interior of the reservoir.

10. The component of claim 4 wherein the shell has an interior bottom wall, and wherein the reservoir contacts the interior bottom wall of the shell when the reservoir is substantially full.

11. A component of a fluid delivery system comprising:
a shell;
a first bag within the shell, the first bag having at least one dimension greater than a corresponding dimension of the shell; and
a second bag within the first bag.

12. The component of claim 11 wherein a length of the first bag is longer than a length of the shell by about half a width of the shell.

13. The component of claim 11 wherein the first and second bags are nested gusset bags.

14. The component of claim 11 wherein the first and second bags are nested pillow-shaped bags.

15. The component of claim 11 wherein the at least one dimension of the second bag is about 25% to about 35% greater than the corresponding dimension of the shell, wherein the first and second bags are flexible to substantially fit within the shell.

16. The component of claim 11 wherein the first and second bags each have an opening along a respective top side, the component further comprising a chassis with a fin to slide into the respective openings, wherein the first and second bags surround and couple with the fin along their top sides to substantially seal the first and second bags, wherein the fin has a tunnel therethrough fluidically coupling with an interior of the second bag.

17. The component of claim 11 wherein the shell has an interior bottom wall, and wherein the first bag contacts the interior bottom wall of the shell when the second bag is substantially full.

18. A component of a fluid delivery system comprising:
a plurality of nested bags having an opening along a top side; and
a chassis with a fin to slide into the opening of the plurality of nested bags, wherein the plurality of nested bags along the top side surrounds and couples with the fin to substantially seal the plurality of nested bags, wherein the fin has a tunnel therethrough fluidically coupling with an innermost nested bag of the plurality of nested bags.

19. The component of claim 18 further comprising a shell with an interior bottom wall, wherein the plurality of nested bags contacts the interior bottom wall of the shell when the plurality of nested bags is substantially full.

20. The component of claim 18 wherein the plurality of nested bags is a plurality of pillow-shaped nested bags.

21. A fluid delivery system comprising:
a shell including a bladder; and
means for substantially completely emptying the bladder.

22. The system of claim 21 wherein the bladder and the means for substantially completely emptying the bladder include a plurality of nested pillow-shaped bags.

23. The system of claim 21 wherein the bladder has a dimension that is greater than a corresponding dimension of the shell, and the bladder and the means for substantially completely emptying the bladder include a plurality of nested bags.

24. The system of claim 21 wherein the bladder and the means for substantially completely emptying the bladder include a plurality of nested bags, the system further comprising a fin about which the bladder forms a seal, wherein the fin has an opening therethrough that is fluidically coupled to an interior of the bladder.

25. The system of claim 21 wherein the bladder includes a pillow-shaped bag, wherein the means for substantially completely emptying the bladder includes the bladder having at least one dimension greater than a corresponding dimension of the shell.

26. The system of claim 25 wherein the bladder has a folded bottom and folded sides in the shell.

27. The system of claim 22 wherein the nested bags are partially sealed together along their periphery and an inner nested bag is sealed together with an outer nested bag partially along a top side of the bladder.

28. A method comprising:
inserting a pillow-shaped reservoir into a shell of a fluid delivery component, wherein the reservoir has at least one dimension that is greater than a corresponding dimension of the shell.

29. The method of claim 28 wherein the reservoir includes a plurality of nested pillow-shaped bags.

30. The method of claim 29 further comprising substantially sealing the bladder along a top side about a fin that has an opening therethrough, the opening being fluidically coupled to an interior of the bladder.

31. The method of claim 28 further comprising folding over a bottom of the reservoir and sides of the reservoir before inserting into the shell.
